(19) United States
(12) Patent Application Publication
(10) Pub. No.: US 2015/0219136 A1
(43) Pub. Date: Aug. 6, 2015

(54) Push Fastener

(71) Applicant: Lockdowel, Inc., Fremont, CA (US)

(72) Inventor: Bryan Koelling, Fremont, CA (US)

(21) Appl. No.: 14/613,335

(22) Filed: Feb. 3, 2015

Related U.S. Application Data
(60) Provisional application No. 61/935,328, filed on Feb. 3, 2014.

(51) Int. Cl. F16B 19/00

(52) U.S. Cl. CPC F16B 19/00

(57) ABSTRACT

A push fastener, comprising: a shaft having a top end and bottom end, the top end integrally connected to a cap; a plurality of barbs spaced along a longitudinal distance of the shaft; and a wedge structure positioned on the shaft between the cap and first barb of the plurality. There is a method of fastening using a push fastener having a shaft including a top end and bottom end, the top end integrally connected to a cap; a plurality of barbs spaced along a longitudinal distance of the shaft; and a wedge structure positioned on the shaft between the cap and first barb of the plurality, the method comprising: inserting the bottom end of the shaft of the push fastener inside a substrate, and applying pressure to the top end of the push fastener.

### CROSS-REFERENCE TO RELATED APPLICATION

This application claims the benefit of U.S. Provisional Application No. 61/935,328, filed Feb. 3, 2014, which is hereby incorporated by reference in its entirety.

### BACKGROUND OF TE INVENTION

1. Field of the Invention

This invention relates to fasteners; more particularly, to single part fasteners having no complementary male to female counter parts. It also pertains to fasteners that use, in one format or another, barbs as the pertinent fastening element.

2. Background

Typical construction methods for manufacturing ready to assemble cabinets and furniture rely on a thin panel of wood, plastic or cardboard like materials that are attached to the back of the product. The back panel serves as a very important aspect to the overall structural integrity of the furniture or cabinet. If the back panel is loosened or removed, the outer frame of the cabinet, furniture or other object is subject to racking (moving from a square or rectangular shape to a parallelogram shape). Small stresses applied to the side of the cabinet or furniture frame will cause this “racking” condition, thus significantly reducing the overall structural integrity of the object.

Most ready to assemble furniture or cabinet items use very small screws or thin finishing nails to accomplish this task of assembly. However, the thin small finishing nails and screws have poor attachment to the materials most typically used (particle board and fiber board) and thus are easily dislodged with a minimum pressure applied to the panel. Finishing nails and screws also require the use of tools for their installation.

Therefore there is a need for a low cost plastic push-pin type fastener that can withstand pull out pressure exceeding fifty pounds and having an insertion force such that it can be installed by pushing into position using hand or thumb pressure only, i.e. no tools required. There is a need for an efficient push fastener to overcome the problems associated with racking, to provide structural integrity and be easily implemented by manual pressure.

### SUMMARY

According to an embodiment of the invention, there is a push fastener comprising an all plastic single component having a pin type configuration. The fastener comprising a domed top cap, a shaft/shank, a plurality of barbs positioned along an outer perimeter of the shank surface, a wedge structure positioned on the shank toward a top of the shank, between the bottom of the dome top cap and the plurality of barbs.

According to an embodiment of the invention, the plurality of barbs along the shaft of the fastener each comprise a flat top portion that is parallel to the underside of the domed top cap. Each barb further comprises an angled bottom portion.

According to an embodiment of the invention, the push fastener further comprises a bottom end having a radial section larger than the diameter of the shaft.

An object of the invention is to provide an easily insertable fastener with manual pressure, without the use of tools, while providing a secure and stable connection to a substrate.

In another embodiment, there is a manually pressed push fastener, comprising: a shaft having a top end and a bottom end, the top end having a surface configured to receive manual pressure; a plurality of tips spaced along a longitudinal distance of the shaft; and a sectioned structure protruding radially from the shaft between the top end and a first tip of the plurality of tips.

In accordance with some embodiments of the present invention, there is a method of fastening using a push fastener comprising a shaft having a top end and a bottom end integrally connected to a cap; a plurality of barbs spaced along a longitudinal distance of the shaft; and a wedge structure positioned on the shaft between the cap and first barb of the plurality; the method comprising: inserting the bottom end of the shaft of the push fastener inside a substrate; and applying pressure to the top end of the push fastener.

These features, advantages and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 illustrates an elevational view of the push fastener according to an embodiment of the present invention.

FIG. 2 illustrates a side elevational view of the fastener, according to an embodiment of the present invention.

FIG. 3 illustrates another elevational view of the fastener, according to an embodiment of the present invention.

FIG. 4 illustrates a bottom perspective view of the fastener, according to an embodiment of the present invention.

FIG. 5 illustrates a top perspective view of the fastener, according to an embodiment of the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

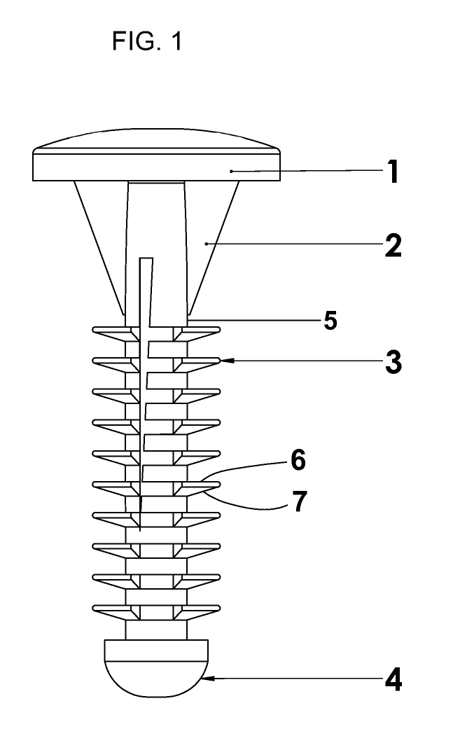

This invention is comprised of an all plastic construction pin configuration with a circular shaped tab located at the top. FIG. 1 represents the fastener according to an embodiment of the present invention, comprising of a top domed cap 1 designed for manual pressure, such as thumb or hand pressure, convenient for pushing in and thus installing the fastener into a drilled hole in the substrate material being used. Attached to the top dome cap 1 of the fastener is a shaft 5 of the fastener, and running vertically downward between the pin top dome cap 1 and the shaft 5 of the fastener is a triangularly shaped wedge structure 2. This sharp edged wedge triangle 2 bites downward and laterally into the top surface of the wood panel, or other substrate, thus firmly securing its position.

This wedge triangle 2 feature also allows a drilled hole located in the substrate, such as a back panel, to be larger in diameter than the complimentary hole drilled into the frame of the structure. This allows for considerable ease of drilled hole location tolerance between the mating parts. A critical element to make this type of fastener comply with a holding strength sufficient to make a robust connection and not loosen overtime to vibration and movement is with the designed structure and geometry of the barbs 3 along the shaft 5 of the fastener.

With respect to the elevational view of FIG. 1, the fastener pin shaft 5 has a plurality of circular barbs 3 spaced evenly, along and extend out from the outer perimeter of the shaft 5, located from a top to a bottom of the shaft 5 of the pin. Each circular barb 3 is constructed such that the top or anterior side 6 of the barb 3 is parallel to the underside of the domed top 1 of the pin. The slope angle 7 of the barb 3 is constructed to be in critical relationship to the barb thickness. The importance of this relationship will define the subsequent arc angle of the barb 3 after insertion into the hole and thus determines the collective holding strength of the plurality of the barbs 3.

The barb length is designed to be in relationship to the drilled hole diameter in the item to be attached, such that a minimum of 45% of the length of the barb 3 is greater than the outside radius of the drilled hole dimension. For ease of location and to start the drive of the pin into a drilled hole, the bottom end 4 of the pin is designed with a large radial section that is equal in diameter to the inside dimension of the drilled hole. According to an embodiment of the present invention, the bottom end 4 radial section has a diameter larger than the diameter of the shaft 5 of the fastener. In another embodiment, the bottom end 4 is bowl-shaped and has a largest diameter that is less than the diameter of the circular barbs 3.

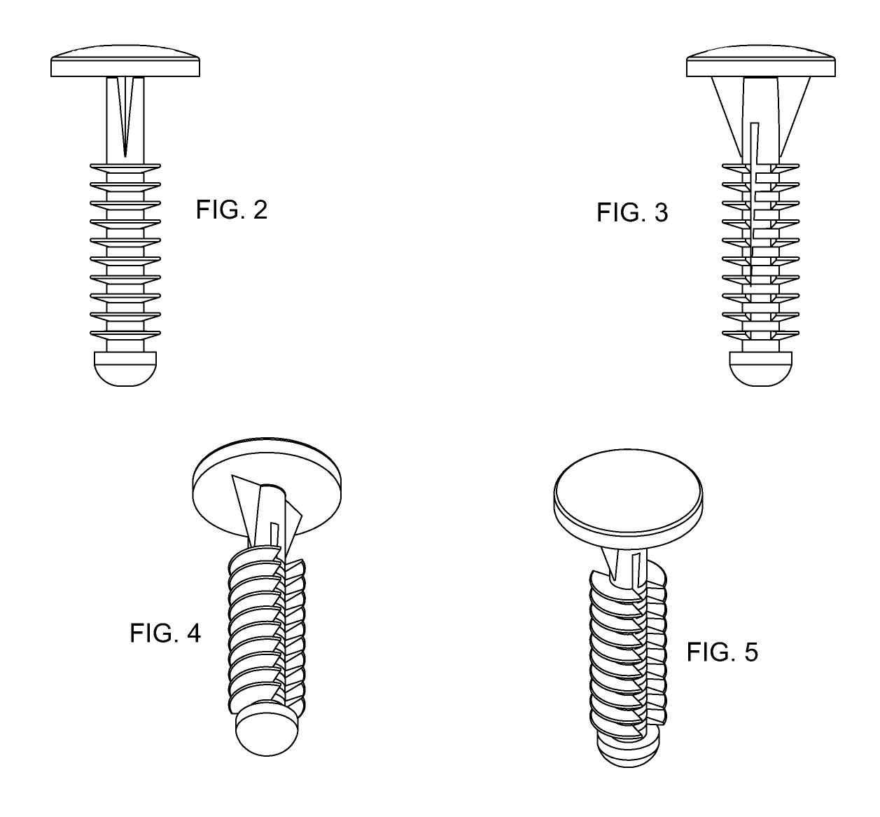

The push fastener is further illustrated in FIGS. 2-5. As shown in the elevational views of FIGS. 2 and 3, and in the perspective views of FIGS. 4 and 5, the wedge structure 2 which flares out from the shaft 5 of the fastener, is further made apparent. As shown, the wedge structure 2 flares out on opposing sides of the shaft 5. According to an embodiment of the present invention, the barbs 3 are configured with a semi-circular shape along two sides of the shaft 5, forming a longitudinal channel on opposing sides of the shaft 5.

The described configuration of the push fastener according to embodiments of the present invention, provides an easily manipulated fastener of low cost and high strength, providing structural integrity with an ability to withstand a pull out force of over 50 pounds. The fastener is manufactured as an entirely integrated plastic piece, keeping costs low and allowing manual insertion into structures without the use of tools, i.e. merely with the use of hand or thumb/finger pressure.

According to an embodiment of the present invention, and as further illustrated in FIGS. 1-5, the push fastener comprises: a cap integrally connected to a shaft; a plurality of circular barbs spaced evenly along a longitudinal distance of the shaft and each barb protruding out from a perimeter of the shaft; a triangular wedge structure position on the shaft and located between a bottom of the cap and the circular barbs; each circular barb having a top side parallel to the underside of the domed top and an angled bottom side; and a terminal end of the shaft having a diameter larger than a diameter of the shaft.

In another embodiment, there is a manually pressed push fastener, comprising: a shaft having a top end and a bottom end, the top end having a surface configured to receive manual pressure; a plurality of tips spaced along a longitudinal distance of the shaft; and a sectioned structure protruding radially from the shaft between the top end and a first tip of the plurality of tips. The top end may further comprise a cap integrally connected to the top end. The sectioned structure may be shaped as a radially extending wedge or sliver. The bottom end may further comprise a portion having a diameter larger than a diameter of the shaft.

Having described some embodiments of the push fastener, a method according to an embodiment of the present invention will now be described with reference to the push fastener. The user may align the bottom end 4 of the push fastener against a substrate, such as a panel of wood. In other embodiments, the alignment of the bottom end 4 may be done against other materials other than wood. The bottom end may be aligned at a pre-designated point on the substrate for example, a drilled hole. The user may apply manual force, for example, using a finger or thumb against the top end 1 of the fastener. Alternatively, the force may be applied using a toe of the user or another body part against the top end 1. Essentially, the fastener is embeddable into the substrate by merely the use of manual pressure as desired. The push fastener may be positioned at a ninety degree angle relative to the point on a panel. Alternatively, the user may position the push fastener at a different angle relative to the point on a panel before applying force against the top end 1. The bottom end 4 will enter the substrate of the panel, allowing each circular barb 3 from the plurality of barbs to connect with the substrate of the panel. The user may continue to apply force against the top 1 until the wedge structure 2 bites into the substrate of the panel. The user may discontinue applying force against the top end 1 when the side of the top end 1 shared with the wedge structure 2 is substantially flush or close against the substrate.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments or alternatives of the foregoing description.

What is claimed is:

1. A push fastener, comprising:
a shaft having a top end and a bottom end, the top end integrally connected to a cap;
a plurality of barbs spaced along a longitudinal distance of the shaft; and
a wedge structure positioned on the shaft between the cap and first barb of the plurality of barbs.

2. The push fastener of claim 1, wherein the plurality of barbs are configured with a semi-circular shape along two sides of the shaft, each barb having an angled bottom portion and a flat top portion parallel to an underside surface of the cap.

3. The push fastener of claim 1, wherein the plurality of barbs are equally positioned along an outer perimeter of the shaft from the cap to the bottom end.

4. The push fastener of claim 1, wherein the wedge structure is triangularly shaped.

5. The push fastener of claim 1, wherein the bottom end has a radial section larger than a diameter of the shaft.

6. The push fastener of claim 1, wherein the bottom end is bowl-shaped, having a largest diameter less than a diameter of the plurality of barbs.

7. The push fastener of claim 1, comprising a plastic material.

8. The push fastener of claim 1, comprising entirely of an integrated plastic material.

9. The push fastener of claim 1, comprising entirely of a molded plastic material.

10. The push fastener of claim 1, wherein a profile of the fastener resembles a push-pin.

11. A manually pressed push fastener, comprising:
a shaft having a top end and a bottom end, the top end having a surface configured to receive manual pressure;
a plurality of tips spaced along a longitudinal distance of the shaft; and
a sectioned structure protruding radially from the shaft between the top end and a first tip of the plurality of tips.

12. The push fastener of claim 11, further comprising a cap integrally connected to the top surface of the top end.

13. The push fastener of claim 11, wherein a portion of the bottom end has a diameter larger than a diameter of the shaft.

14. A method of fastening using a push fastener, the push fastener comprising a shaft having a top end and a bottom end integrally connected to a cap; a plurality of barbs spaced along a longitudinal distance of the shaft; and a wedge structure positioned on the shaft between the cap and first barb of the plurality; the method comprising:
inserting the bottom end of the shaft of the push fastener inside a substrate, and applying a pressure to the top end of the push fastener.

15. The method of claim 14, wherein inserting the push fastener requires no use of a tool.

16. The method of claim 14, wherein inserting the push fastener uses only manual pressure.

17. The method of claim 14, wherein upon applying the pressure, the plurality of barbs embeds into the substrate.

18. The method of claim 14, wherein upon applying the pressure, the wedge structure bites into the substrate.

19. The method of claim 14, wherein applying the pressure to the push fastener continues until the wedge structure reaches into the substrate.

20. The method of claim 19, wherein the push fastener withstands a pull out force of over 50 pounds.
